(19) United States
(12) Patent Application Publication
(10) Pub. No.: US 2026/0032630 A1
(43) Pub. Date: Jan. 29, 2026

(54) CONFIGURATION AND SELECTION OF SIDELINK POSITIONING REFERENCE SIGNAL RESOURCE

(71) Applicant: TOYOTA JIDOSHA KABUSHIKI KAISHA, Toyota-shi (JP)

(72) Inventors: Takayuki SHIMIZU, Mountain View, CA (US); Hongsheng LU, Mountain View, CA (US); Kai-Erik SUNELL, Naantali (FI); Claude ARZELIER, Varna (BG); John KENNEY, Mountain View, CA (US); Onur ALTINTAS, Mountain View, CA (US); Stepan KUCERA, Munich (DE); Torsten WILDSCHEK, Gloucester (GB); Diomidis MICHALOPOULOS, Munich (DE); Taylan SAHIN, Munich (DE); Prajwal KESHAVAMURTHY, Munich (DE); Mikko SAILY, Laukkoski (FI)

(73) Assignee: TOYOTA JIDOSHA KABUSHIKI KAISHA, Toyota-shi (JP)

(21) Appl. No.: 19/349,647

(22) Filed: Oct. 3, 2025

Related U.S. Application Data
(63) Continuation of application No. PCT/JP2024/007510, filed on Feb. 29, 2024.
(60) Provisional application No. 63/457,255, filed on Apr. 5, 2023.

(51) Int. Cl. H04W 64/00; H04L 5/00; H04W 4/40; H04W 92/18

(52) U.S. Cl. CPC H04W 64/00; H04L 5/0048; H04W 4/40; H04W 92/18

(57) ABSTRACT

Disclosed are methods, apparatuses, and systems for a UE for positioning. The method includes: determining at least one of: one or more sidelink-positioning reference signal (SL-PRS) resource sets in a slot, or one or more SL-PRS resource set patterns for one or more slots, the one or more SL-PRS resource sets being configured or pre-configured for one or more SL-PRS transmissions for one or more UEs including the UE; selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and transmitting at least one of: one or more SL-PRS signals or SL-PRS control information.

### CROSS-REFERENCE TO RELATED PATENT APPLICATION

This application claims the benefit of U.S. Provisional Application No. 63/457,255, filed on Apr. 5, 2023, entitled “CONFIGURATION AND SELECTION OF SL-PRS RESOURCE SETS TO MITIGATE NEAR-FAR PROBLEM DUE TO IN-BAND EMISSION INTERFERENCE,” the entirety of which is incorporated by reference herein.

### FIELD

Apparatuses and methods consistent with the present disclosure relate generally to communications, more specifically, methods, systems, and devices for configuration and selection of sidelink positioning reference signal resource sets in a communication.

### BACKGROUND

User equipment (UE) in a communication, such as a vehicle in a vehicle-to-everything (V2X) communication, needs to obtain timely, accurate position information for various purposes. The UE may obtain the position information using conventional positioning methods, for example, based on the signals transmitted/received to/from a global navigation satellite system (GNSS) or a network node (e.g., a base station). However, if the UE is located in an area where such signals are intermittent or unreliable, for example, in a parking garage or a tunnel, the UE may not obtain the position information.

Sidelink positioning based on a sidelink positioning reference signal (SL-PRS) may provide solutions for the above-noted issues in conventional positioning methods. For sidelink positioning, the UE (a transmitter UE) needs to transmit a SL-PRS to a receiver UE. However, if there is another transmitter UE in the sidelink communication that also transmits a SL-PRS to the same receiver UE, the signal from the other transmitter UE may interfere with the signal from the UE at the receiver UE, causing degradation of positioning accuracy. The effect of such degradation of positioning accuracy is more severe if the SL-PRS resource sets for the two transmitter UEs are configured or pre-configured as a comb-based SL-PRS resource sets and the two transmitter UEs transmit SL-PRS signals in a periodic or a semi-persistent scheduling manner by multiplexing the comb-based SL-PRS resource sets, causing persistent or a semi-persistent signal interference for a long period. Systems and methods for configuration and selection of SL-PRS resource sets that can mitigate signal interferences and improve sidelink positioning accuracy are desired.

### SUMMARY

According to some embodiments of the present disclosure, there is provided a UE for a sidelink positioning. The UE includes a memory storing an instruction; and a processor configured to execute the instruction stored in the memory to: determine at least one of: one or more SL-PRS resource sets in a slot, or one or more SL-PRS resource set patterns for one or more slots, the one or more SL-PRS resource sets being configured or pre-configured for one or more SL-PRS transmissions for one or more UEs including the UE; select at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and transmit, based on the selected at least one SL-PRS resource set, at least one of: one or more SL-PRS signals or SL-PRS control information.

According to some embodiments of the present disclosure, there is provided a node for a sidelink positioning. The node includes a memory storing an instruction; and a processor configured to execute the instruction stored in the memory to: configure one or more SL-PRS resource sets for one or more UEs including a first UE; obtain information regarding a positioning accuracy of the first UE; and determine whether to deactivate at least one SL-PRS resource set configured for the first UE and to configure at least one other SL-PRS resource set for the first UE.

According to some embodiments of the present disclosure, there is provided a method for a UE in a sidelink positioning. The method includes determining at least one of: one or more SL-PRS resource sets in a slot, or one or more SL-PRS resource set patterns for one or more slots, the one or more SL-PRS resource sets being configured or pre-configured for one or more SL-PRS transmissions for one or more UEs including the UE; selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and transmitting, based on the selected at least one SL-PRS resource set, at least one of: one or more SL-PRS signals or SL-PRS control information.

According to some embodiments of the present disclosure, there is provided a method involving a node for a sidelink positioning. The method includes configuring one or more SL-PRS resource sets for one or more UEs including a first UE; obtaining information regarding a positioning accuracy of the first UE; and determining whether to deactivate at least one SL-PRS resource set configured for the first UE and to configure at least one other SL-PRS resource set for the first UE.

According to some embodiments of the present disclosure, there is provided a non-transitory computer-readable medium storing instructions that are executable by one or more processors of a UE in a sidelink positioning. The method includes determining at least one of: one or more SL-PRS resource sets in a slot, or one or more SL-PRS resource set patterns for one or more slots, the one or more SL-PRS resource sets being configured or pre-configured for one or more SL-PRS transmissions for one or more UEs including the UE; selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and transmitting, based on the selected at least one SL-PRS resource set, at least one of: one or more SL-PRS signals or SL-PRS control information.

According to some embodiments of the present disclosure, there is provided a non-transitory computer-readable medium storing instructions that are executable by one or more processors of a node for a sidelink positioning to perform a method. The method includes configuring one or more SL-PRS resource sets for one or more UEs including a first UE; obtaining information regarding a positioning accuracy of the first UE; and determining whether to deactivate at least one SL-PRS resource set configured for the first UE and to configure at least one other SL-PRS resource set for the first UE.

### BRIEF DESCRIPTION OF DRAWINGS

FIGS. 1A-1C are schematic diagrams illustrating some exemplary scenarios where conventional positioning is not available or accurate, consistent with some embodiments of the present disclosure.

FIG. 2 is a schematic diagram illustrating a sidelink positioning, consistent with some embodiments of the present disclosure.

FIG. 3 is a schematic diagram illustrating an exemplary downlink positioning reference signal (DL-PRS) resource mapping, consistent with some embodiments of the present disclosure.

FIG. 4 is a schematic diagram illustrating an exemplary SL-PRS resource mapping, consistent with some embodiments of the present disclosure.

FIG. 5 is a schematic diagram illustrating occurrence of an in-band emission interference among two or more UEs transmitting SL-PRS signals using one or more SL-PRS resource sets in the same slot, consistent with some embodiments of the present disclosure.

FIG. 6A is a schematic diagram illustrating an exemplary SL-PRS resource mapping.

FIG. 6B is a schematic diagram illustrating another exemplary SL-PRS resource mapping.

FIG. 6C is a schematic diagram illustrating another exemplary SL-PRS resource mapping, consistent with some embodiments of the present disclosure.

FIG. 7A is a schematic diagram illustrating an exemplary SL-PRS resource mapping including a first SL-PRS resource set pattern.

FIG. 7B is a schematic diagram illustrating an exemplary SL-PRS resource mapping including a second SL-PRS resource set pattern.

FIG. 7C is a schematic diagram illustrating an exemplary SL-PRS resource mapping including a third SL-PRS resource set pattern, consistent with some embodiments of the present disclosure.

FIG. 8 is a schematic diagram illustrating a method for a UE in a sidelink positioning, consistent with some embodiments of the present disclosure.

FIG. 9 is a schematic diagram illustrating a method involving a node for a sidelink positioning, consistent with some embodiments of the present disclosure.

FIG. 10 is a block diagram of a device, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

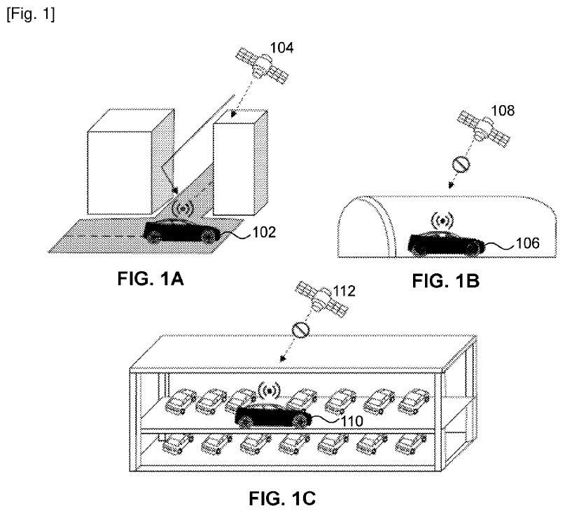

FIGS. 1A-1C are schematic diagrams illustrating some exemplary scenarios where conventional positioning is not available or accurate, consistent with some embodiments of the present disclosure. A UE (which is an example of a mobile node) in a communication, such as a vehicle in a V2X communication, needs to obtain timely, accurate positioning information for various purposes. The term “node” is used in this disclosure as a general term which can be user equipment, a relay node, a road side unit, a vehicle, a vehicle mounted module, or a network infrastructure device (e.g., a base station, a relaying device, a wireless router, a controller, an access point). For many V2X services, position information is one of the essential data elements that need to be exchanged over V2X communications. In a V2X communication, position information may be exchanged via a basic safety message (BSM), a collective perception message (CPM), a maneuver coordination message (MCM), or a personal safety message (PSM), etc. To obtain the position information, the UE may use conventional positioning methods, for example, based on transmission/reception of global navigation satellite system (GNSS) signals to/from a satellite. However, precise positioning using GNSS signals is challenging in some scenarios, and FIGS. 1A-1C schematically illustrate such challenging scenarios. Referring to FIG. 1A, a UE 102 (e.g., a vehicle) in urban canyons may try to obtain positioning information using GNSS signals transmitted from a satellite 104. However, due to non-light-of-sight (NLOS) and multipath in the urban canyons, the UE 102 may not receive the GNSS signals and thus, GNSS-based positioning may not be available or accurate in this scenario. Referring to FIG. 1B, a UE 106 (e.g., a vehicle) in a tunnel may also experience the same challenge when the UE tries to obtain positioning information using GNSS signals transmitted from a satellite 108 because the tunnel blocks the transmission of the GNSS signals. Similarly, as shown in FIG. 1C, a UE 110 (e.g., a vehicle) in a parking garage may encounter similar difficulty when the UE tries to obtain positioning information using GNSS signals transmitted from a satellite 112 because the garage building blocks the transmission of the GNSS signals.

The UE (e.g., the UE 102, the UE 106, or the UE 110) may also use other conventional positioning methods, for example, an inertial measurement unit (IMU)/dead reckoning. However, in the IMU/dead reckoning, the positioning error generally increases over distance, causing reduced accuracy in positioning. The UE may also try to use a Uu-based positioning method based on signals communicated with a network node (e.g., a base station). However, the signals from the network node are not available if the UE is outside of a coverage area of the network node. Sidelink positioning may provide solutions for the above-mentioned scenarios, as discussed below.

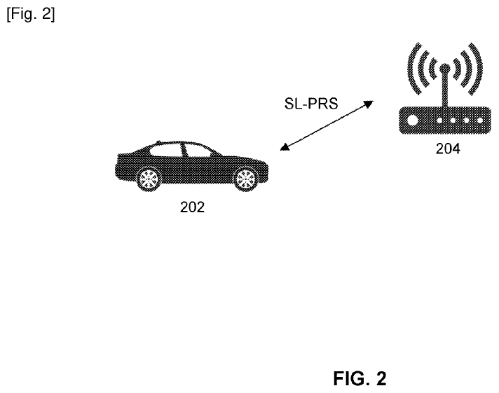

FIG. 2 is a schematic diagram illustrating a sidelink positioning, consistent with some embodiments of the present disclosure. To address the challenges in conventional positioning methods as described with respect to FIGS. 1A-C, at least some embodiments of the present disclosure are directed to sidelink positioning. Referring to FIG. 2, in a sidelink positioning, a target node 202 (e.g., a vehicle, pedestrian(s), etc.) and an anchor node 204 (e.g., a road side unit) may transmit/receive SL-PRS signals to determine the position of the target node 202. For example, the position of the target node 202 can be determined by measuring a round-trip time (RTT) of the SL-PRS signals, a relative time of arrival (RTOA) of the SL-PRS signals, an angle of arrival (AoA) of the SL-PRS signals, or a zenith of arrival (ZoA) of the SL-PRS signals, etc. The positioning can be an absolute positioning that determines coordinates of the target node 202 and/or a relative positioning that determines a relative position of the target node 202 relative to another node (e.g., the anchor node 204). Transmission of SL-PRS signals may require radio resources (e.g., time and/or frequency resources). At least some embodiments of the present disclosure use comb-based SL-PRS resource mappings that are similar to DL-PRS resource mappings, as discussed below.

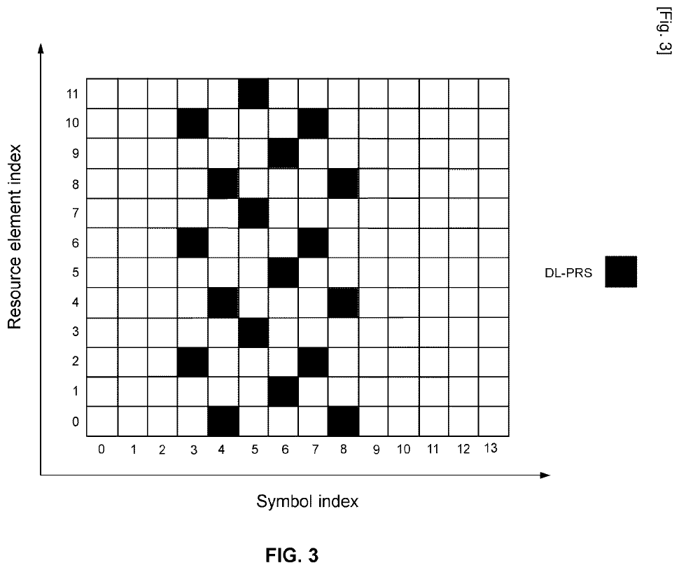

FIG. 3 is a schematic diagram illustrating an exemplary DL-PRS resource mapping, consistent with some embodiments of the present disclosure. As shown in FIG. 3, the DL-PRS resource mapping is a comb-based mapping. A radio resource may be composed of time resource and/or frequency resource. In FIG. 3, the horizontal axis indicates time resource, and the vertical axis indicates frequency resource. The comb-based resource mapping in FIG. 3 includes one resource set that includes a plurality of resource elements (RE) illustrated with black squares. As shown in FIG. 3, in the horizontal axis, each resource element corresponds to a one symbol length. FIG. 3 shows 14 symbols in the horizontal axis, which constitute one slot. In the DL-PRS mapping shown in FIG. 3, the separation of two adjacent resource elements in the horizontal direction is 3, and the separation of two adjacent resource elements in the vertical direction is also 3. In some embodiments, the DL-PRS resource set in FIG. 3 may be associated with a resource ID, a comb size, a comb offset, a starting symbol of the slot, or the number of symbols within the slot. The DL-PRS resource mapping in FIG. 3 is merely exemplary, and the scope of the present application is not so limited. The DL-PRS resource mapping of the present disclosure can include any number of resource sets and can form any resource set pattern.

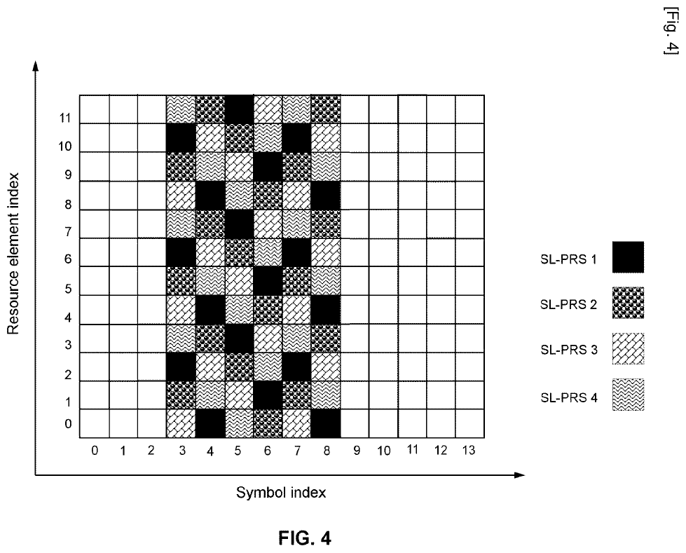

FIG. 4 is a schematic diagram illustrating an exemplary SL-PRS resource mapping, consistent with some embodiments of the present disclosure. As shown in FIG. 4, the SL-PRS resource mapping is a comb-based mapping. Referring to FIG. 4, an exemplary SL-PRS resource mapping includes four different SL-PRS resource sets in a slot: SL-PRS 1, SL-PRS 2, SL-PRS 3, and SL-PRS 4. The four different SL-PRS resource sets may be configured for one or more UEs. The one or more UEs may multiplex resource elements from these four different resource sets. In some embodiments, a SL-PRS resource is composed of time and/or frequency. In some embodiments, each of the four SL-PRS resource sets may be associated with at least one of: a resource ID, a comb size, a comb offset, a starting symbol of the slot, or the number of symbols within the slot. In the scenario where the four different SL-PRS resource sets are configured for multiple UEs (e.g., 4 UEs), multiplexing the comb-based SL-PRS resources from the four different SL-PRS resource sets may cause in-band emission (IBE) interference among the multiple UEs transmitting SL-PRS signals using the SL-PRS resource sets in the same slot, as described below.

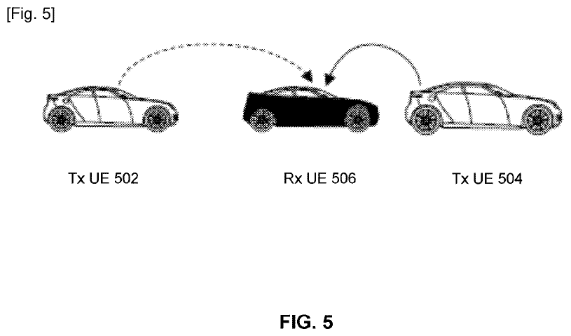

FIG. 5 is a schematic diagram illustrating occurrence of an in-band emission interference among two or more UEs transmitting SL-PRS signals using one or more SL-PRS resource sets in the same slot, consistent with some embodiments of the present disclosure. Referring to FIG. 5, a transmitter (Tx) UE 502 and a Tx UE 504 may use one or more resource sets in the same slot for SL-PRS transmissions. For example, the Tx UE 502 may use SL-PRS 2 of FIG. 4, and the Tx UE 504 may use SL-PRS 1 of FIG. 4, which is adjacent to the SL-PRS 2 in vertical direction (frequency domain). Both the Tx UE 502 and the Tx UE 504 transmit SL-PRS signals to an Rx UE 506. The Tx UE 502 is far from the Rx UE 506, while the Tx UE 504 is close to the Rx UE 506. In this case, the leakage of the signals from the Tx UE 504 (i.e., IBE) interferes with the signals from the Tx UE 502 at the Rx UE 506, causing degradation of the positioning accuracy of sidelink positioning. In the present disclosure, this phenomenon is called near-far problem caused by IBE interference. The effect of such degradation of positioning accuracy is more severe if multiple Tx UEs transmit SL-PRS signals in a periodic and/or a semi-persistent scheduling (SPS) manner based on a comb-based multiplexing of the SL-PRS resource sets in the same slot, because this causes a persistent or a semi-persistent near-far problem. In such cases, the near-far problem may occur in consecutive SL-PRS transmissions, causing degradation of the positioning accuracy for a longer period.

At least some embodiments of the present disclosure provide solutions to mitigate the near-far problem caused by IBE interference. For example, in some embodiments, each Tx UE may use a SL-PRS resource set with less impact of IBE interference for each SL-PRS transmission and/or use a different SL-PRS resource set for periodic or semi-periodic SL-PRS transmissions to mitigate the persistent or semi-persistent near-far problem. According to some embodiments of the present disclosure, to mitigate the near-far problem, for example, a Tx UE may select one or more SL-PRS resource sets used for one or more subsequent SL-PRS transmissions based on random selection from available SL-PRS resource sets and/or based on configured or pre-configured SL-PRS resource set patterns and/or its own sensing information and/or control signaling and/or assistance information from one or more other Tx UEs or Rx UEs and/or a network node. In addition, a Tx UE may transmit control information for SL-PRS signals that indicates the SL-PRS resource set information for one or more subsequent SL-PRS transmissions (e.g., initial transmission and/or retransmission(s) in the current SPS period and/or subsequent SPS period(s)), so that the surrounding one or more UEs can be aware of the SL-PRS resource sets to avoid selecting reserved SL-PRS resource sets and SL-PRS resource sets that may experience IBE interference.

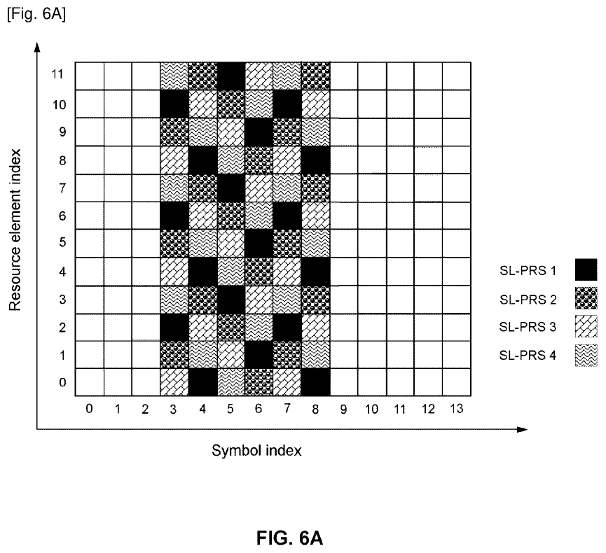

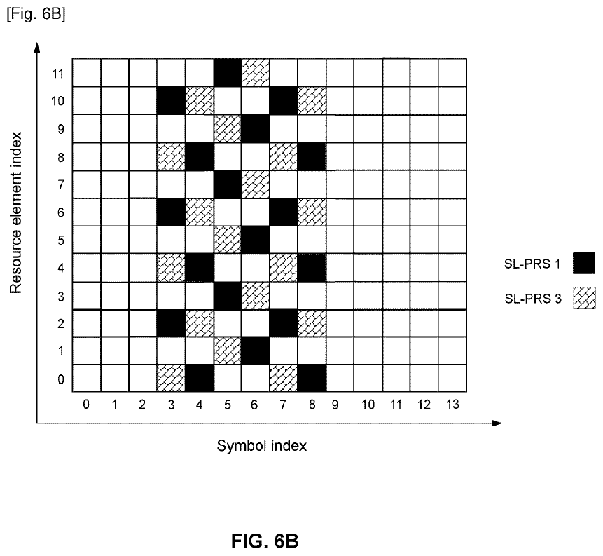

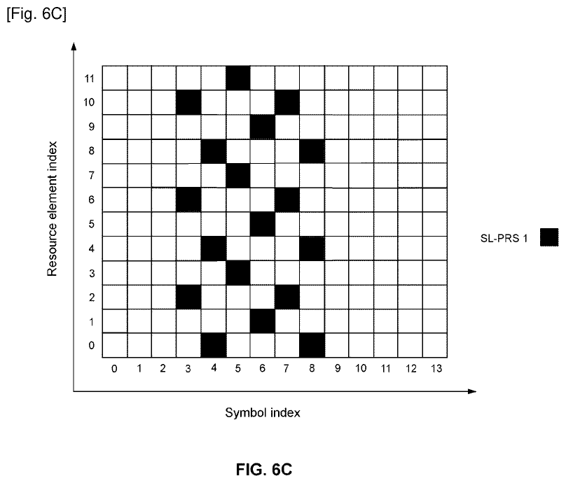

FIG. 6A is a schematic diagram illustrating an exemplary SL-PRS resource mapping, FIG. 6B is a schematic diagram illustrating another exemplary SL-PRS resource mapping, and FIG. 6C is a schematic diagram illustrating another exemplary SL-PRS resource mapping, consistent with some embodiments of the present disclosure. Referring to FIG. 6A, an exemplary SL-PRS resource mapping includes four different SL-PRS resource sets in a slot, they are: SL-PRS 1, SL-PRS 2, SL-PRS 3, and SL-PRS 4. In FIG. 6A, the separation value between two adjacent resource elements in horizontal axis and in vertical axis is zero. Referring to FIG. 6B, an exemplary SL-PRS resource includes two different SL-PRS resource sets in a slot, they are: SL-PRS 1 and SL-PRS 3. In FIG. 6B, the separation value of two adjacent resource elements for the SL-PRS 1 and the SL-PRS 3 in horizontal axis is zero and in vertical axis is one. Referring to FIG. 6C, an exemplary SL-PRS resource includes one SL-PRS resource set in a slot, it is: SL-PRS 1. In FIG. 6C, the separation value of two adjacent resource elements for the SL-PRS 1 in horizontal axis and in vertical axis is three.

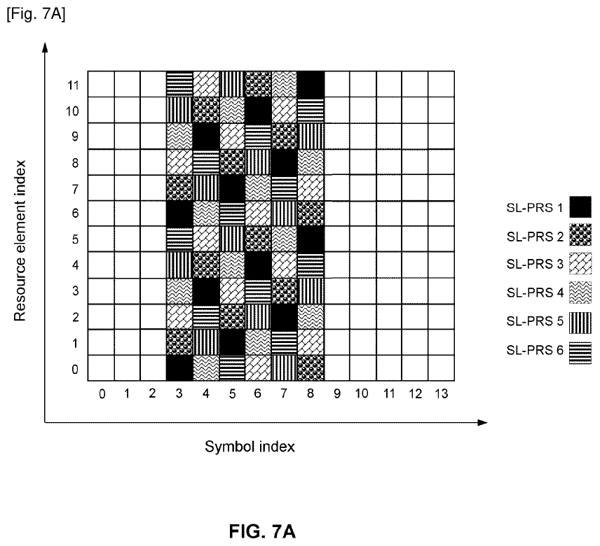

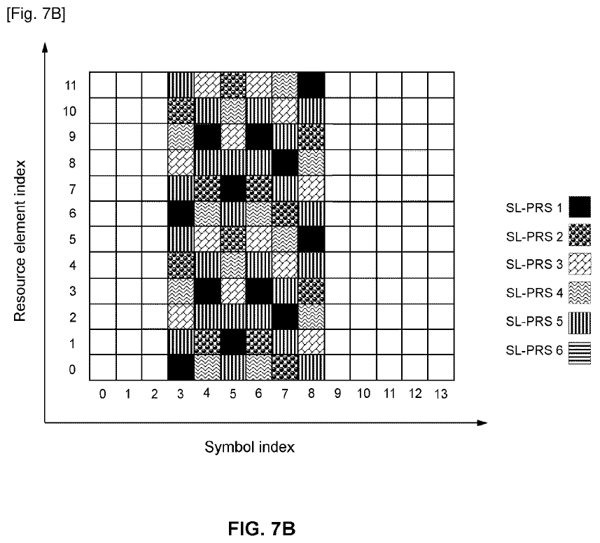

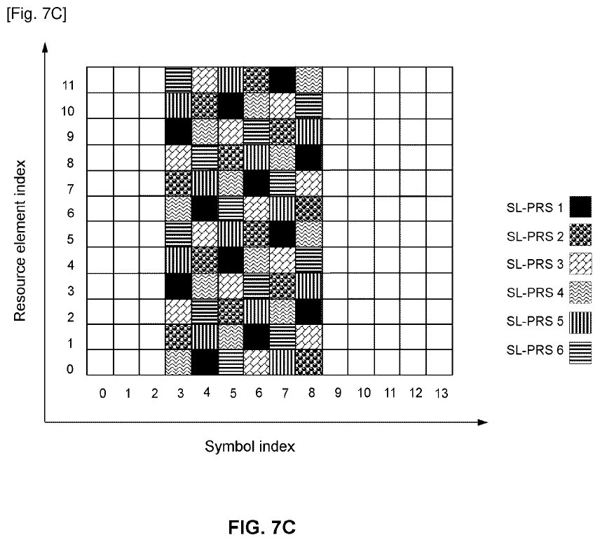

The three SL-PRS resource mappings as shown in FIG. 6A-6C are merely exemplary resource mapping, and the scope of the present application is not so limited. In some embodiments, SL-PRS resource mappings are configured, pre-configured, or pre-defined such that any number of SL-PRS resource sets may be included in one slot or any separation value between two adjacent resource elements may be adopted, based on the effect of near-far problem and/or positioning accuracy requirement and/or priorities of the SL-PRS signals and/or congestion metrics associated with the SL-PRS signals, etc. In some embodiments, the near-far problem is mitigated by configuring or pre-configuring or defining or pre-defining different SL-PRS resource set patterns, as described with respect to FIGS. 7A-7C below.

FIG. 7A is a schematic diagram illustrating an exemplary SL-PRS resource mapping including a first SL-PRS resource set pattern, FIG. 7B is a schematic diagram illustrating an exemplary SL-PRS resource mapping including a second SL-PRS resource set pattern, and FIG. 7C is a schematic diagram illustrating an exemplary SL-PRS resource mapping including a third SL-PRS resource set pattern, consistent with some embodiments of the present disclosure. Referring to FIG. 7A, an exemplary SL-PRS resource mapping includes six different SL-PRS resource sets in a slot, they are: SL-PRS 1, SL-PRS 2, SL-PRS 3, SL-PRS 4, SL-PRS 5, and SL-PRS 6. The arrangement (sequence) of the resource elements of the six different SL-PRS resource sets forms a first SL-PRS resource set pattern, as shown in FIG. 7A. In FIG. 7A, there is no separation between two adjacent resource elements in both horizontal axis and vertical axis. Referring to FIG. 7B, an exemplary SL-PRS resource mapping includes the same six SL-PRS resource sets (SL-PRS 1, SL-PRS 2, SL-PRS 3, SL-PRS 4, SL-PRS 5, and SL-PRS 6) in a slot. But compared with FIG. 7A, the arrangement (sequence) of the resource elements of the six different SL-PRS resource sets is different in FIG. 7B. The arrangement of the resource elements of the six different SL-PRS source sets in FIG. 7B forms a second SL-PRS resource set pattern. In FIG. 7B, there is also no separation between two adjacent resource elements in both horizontal axis and vertical axis. Referring to FIG. 7C, an exemplary SL-PRS resource mapping includes the same six SL-PRS resource sets (SL-PRS 1, SL-PRS 2, SL-PRS 3, SL-PRS 4, SL-PRS 5, and SL-PRS 6) in a slot. The arrangement of the resource elements of the six SL-PRS resource sets forms a third SL-PRS resource set pattern, which is different from the first and second SL-PRS resource set patterns. In FIG. 7C, there is also no separation between two adjacent resource elements in both horizontal axis and vertical axis.

The three SL-PRS resource set patterns as shown in FIG. 7A-7C are merely exemplary resource set patterns, and the scope of the present application is not so limited. In some embodiments, any types of SL-PRS resource set patterns are configured, pre-configured, defined, or pre-defined, based on the effect of near-far problem and/or positioning accuracy requirement.

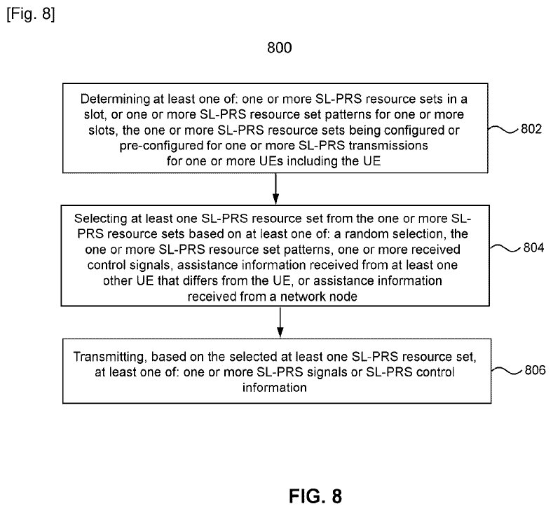

FIG. 8 is a schematic diagram illustrating a method for a UE in a sidelink positioning, consistent with some embodiments of the present disclosure. The UE can be any UE or mobile node in a communication system, for example, a vehicle or a pedestrian. For example, in an embodiment, the UE may be the target node 202 of FIG. 2. Referring to FIG. 8, a method 800 includes a step 802 of determining at least one of: one or more SL-PRS resource sets in a slot, or one or more SL-PRS resource set patterns for one or more slots, the one or more SL-PRS resource sets being configured or pre-configured for one or more SL-PRS transmissions for one or more UEs including the UE. The slot may be a slot of a dedicated SL-PRS resource pool or a slot of a shared SL-PRS resource pool. The one or more SL-PRS resource sets may be at least one of: one or more time resources, or one or more frequency resources. In some embodiments, each of the one or more SL-PRS resource sets may be associated with at least one of: a SL-PRS resource identifier (ID), a SL-PRS comb size, a SL-PRS comb offset, a starting symbol of the slot, or a number of SL-PRL symbols within the slot. In some embodiments, the one or more SL-PRS resource sets may be one or more active SL-PRS resource sets that are configured or pre-configured to be available for at least one slot. For example, the one or more SL-PRS resource sets may be the SL-PRS 1 of FIG. 6C, or the SL-PRS 1 and the SL-PRS 3 of FIG. 6B, or the SL-PRS 1, the SL-PRS 2, the SL-PRS 3, and the SL-PRS 4 of FIG. 6A. In some embodiments, the one or more SL-PRS resource sets may be configured or pre-configured such that each of the one or more SL-PRS resource sets has a corresponding SL-PRS resource ID. For example, in some embodiments, each of the SL-PRS 1, the SL-PRS 2, the SL-PRS 3, and the SL-PRS 4 of FIG. 6A has a corresponding SL-PRS resource ID.

In some embodiments, the one or more SL-PRS resource sets may be configured or pre-configured based on at least one of: one or more priorities of the one or more SL-PRS signals, or one or more congestion metrics associated with the one or more SL-PRS signals. For example, the one or more congestion metrics associated with the one or more SL-PRS signals may include at least one of channel busy ratio (CBR) or channel occupancy ratio (CR). In some embodiments, the one or more SL-PRS resource sets may be configured or pre-configured such that, in the at least one slot, the one or more SL-PRS resource sets are associated with an odd resource set index or an even resource set index.

In some embodiments, the one or more SL-PRS resource sets may be configured or pre-configured such that, in the at least one slot, a separation between two resource elements for any two SL-PRS resource sets in the one or more SL-PRS resource sets is equal to or greater than an integer. The integer may be configured or pre-configured. The two resource elements for any two SL-PRS resource sets in the one or more SL-PRS resource sets may be two adjacent resource elements. For example, in FIG. 4, the resource element having symbol index of 4 and the resource element index of 0, and the resource element having symbol index of 4 and the resource element index of 3 are two adjacent resource elements for two SL-PRS resource sets (the SL-PRS 1 and the SL-PRS 2) and the separation between these two resource elements is 2. The separation between the two resource elements for any two SL-PRS resource sets in the one or more SL-PRS resource sets may be at least one of: a separation in frequency domain, or a separation in time domain. For example, the separation of 2 mentioned in the above example in FIG. 4 is a separation in frequency domain.

In some embodiments, the one or more SL-PRS resource sets may be configured or pre-configured such that a wider separation between two resource elements for any two SL-PRS resource sets in the one or more SL-PRS resource sets may be used for a SL-PRS signal having at least one of: a lower congestion level or a higher priority. On the other hand, a narrower separation between two resource elements for any two SL-PRS resource sets in the one or more SL-PRS resource sets may be used for a SL-PRS signal having at least one of: a higher congestion level or a lower priority. The separation between the two resource elements for any two SL-PRS resource sets in the one or more SL-PRS resource sets may be at least one of: a separation in frequency domain, or a separation in time domain. In some embodiments, the two resource elements for any two SL-PRS resource sets in the one or more SL-PRS resource sets are two adjacent resource elements. For example, FIG. 6B shows that the separation between two adjacent resource elements for two SL-PRS resource sets (SL-PRS 1 and SL-PRS 3) in frequency domain is 1, while FIG. 6A shows that the separation between the same two adjacent resource elements for the two SL-PRS resource sets (SL-PRS 1 and SL-PRS 3) in frequency domain is 0. The SL-PRS resource mapping in FIG. 6B is configured or pre-configured to have a wider separation between two adjacent resource elements than that of FIG. 6A, for example, when the SL-PRS of FIG. 6B has a lower congestion level and/or a higher priority than that of FIG. 6A.

In some embodiments, the one or more SL-PRS resource set patterns may include a plurality of SL-PRS resource set patterns and the one or more slots may be associated with at least one SL-PRS resource set pattern from among the one or more SL-PRS resource set patterns. For example, FIGS. 7A-7C show three different SL-PRS resource set patterns (the first SL-PRS resource set pattern, the second SL-PRS resource set pattern, and the third SL-PRS resource set pattern), and the slot in FIG. 7A is associated with the first SL-PRS resource set pattern, the slot in FIG. 7B is associated with the second SL-PRS resource set pattern, and the slot in FIG. 7C is associated with the third SL-PRS resource set pattern. The one or more SL-PRS resource set patterns may be configured or pre-configured, and each of the one or more SL-PRS resource set patterns may be associated with the one or more slots. In some embodiments, the at least one SL-PRS resource set pattern associated with the one or more slots may be different from one or more SL-PRS resource set patterns of an integer number of adjacent slots. The integer may be configured or pre-configured. In some embodiments, the at least one SL-PRS resource set pattern may be associated with an integer number of consecutive slots, where the integer is configured or pre-configured. In some embodiments, the at least one SL-PRS resource set pattern may be associated with one or more slots identified by one or more mapping tables. The one or more mapping tables may include a mapping between the at least one SL-PRS resource set pattern and the identified one or more slots. The one or more mapping tables may be configured or pre-configured.

In some embodiments, the one or more SL-PRS resource sets may be a plurality of SL-PRS resource sets configured or pre-configured for a plurality of UEs including the UE, and each of the plurality of UEs may be associated with a corresponding SL-PRS resource set of the plurality of SL-PRS resource sets. For example, in FIG. 4, the four SL-PRS resource sets (SL-PRS 1, SL-PRS 2, SL-PRS 3, and SL-PRS 4) may be configured or pre-configured for four UEs such that each of the four UEs is associated with a corresponding SL-PRS resource set of the four SL-PRS resource sets.

The method 800 includes a step 804 of selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node. In some embodiments, the UE may select, from the one or more SL-PRS resource sets, at least one specific SL-PRS resource set corresponding to the UE, for at least one slot. In some embodiments, the UE may use, for each SL-PRS transmission, a different SL-PRS resource set from among the one or more SL-PRS resource sets, based on one or more rotation patterns of selection. For example, the one or more SL-PRS resource sets may be rotated every periodic SL-PRS transmission. The one or more rotation patterns of selection may be derived based on at least one of: a zone at which the UE is located, an anchor group associated with the UE, or a positioning session associated with the UE. For example, anchor UEs sharing the same mobility pattern (e.g., anchor UEs following the same target UE on the highway) may use rotation patterns leading to adjacent SL-PRS while anchor UEs with different mobility patterns and potentially suffering from mutual Doppler shift may use antagonistic rotation patterns. The one or more rotation patterns may be configured by a network node or pre-configured at the UE.

In some embodiments, the UE may perform or obtain its own channel sensing information. The UE may select, from the one or more SL-PRS resource sets, randomly or based on the obtained channel sensing information, at least one specific SL-PRS resource set corresponding to the UE, for one or more SL-PRS signal transmissions. For example, the UE may select the at least one SL-PRS resource set for at least one of: one or more initial transmissions in a SPS, one or more retransmissions in a SPS, or one or more transmissions in one-shot transmission.

In some embodiments, the UE may select, from among one or more available radio resources with granularity of at least one of: one or more time resources or one or more frequency resources, randomly or based on obtained channel sensing information, one or more radio resources with granularity of at least one of: one or more slots or one or more sub-channels. The UE may further select, from among the selected one or more radio resources, randomly or based on the obtained channel sensing information, the one or more SL-PRS resource sets, with a granularity of a SL-PRS resource set. For example, the granularity of at least one of: one or more time resources or one or more frequency resources may be the granularity of at least one of: one or more slots or one or more sub-channels. In this way, the random selection for SL-PRS resource sets disclosed in the present disclosure provides additional randomness to mitigate the near-far problem.

In some embodiments, the UE may be a first transmitter UE that receives from a second transmitter UE, SL-PRS control signals (information) generated by the second transmitter UE. The received SL-PRS control information may include SL-PRS resource set information for the second transmitter UE for at least one of: one or more current SL-PRS transmissions, or one or more subsequent transmissions. The control information may include at least one of: (1) SL-PRS resource set information for one or more initial transmissions in a current SPS period, (2) SL-PRS resource set information for one or more retransmissions in the current SPS period, (3) SL-PRS resource set information for one or more initial transmissions in at least one subsequent SPS period, or (4) SL-PRS resource set information for one or more retransmissions in at least one subsequent SPS period. The UE may receive the SL-PRS control information via a direct communication or via a network node.

Based on the received SL-PRS control information, the UE (the first transmitter UE) may further determine whether to select or re-select one or more SL-PRS resource sets, while ensuring a minimum separation between a resource element of the one or more SL-PRS resource sets for the first transmitter UE and a resource element of the one or more SL-PRS resource sets for the second transmitter UE. The minimum separation may be configured or pre-configured. For example, the minimum separation may be one (or any other number of) resource element length in frequency domain. In some embodiments, the UE (the first transmitter UE) may further determine whether to adjust a transmitter power for the first transmitter UE, based on at least one of: a position of the first transmitter UE, a position of the second transmitter UE, a mobility of the first transmitter UE, or a mobility of the second transmitter UE. In some embodiments, in response to a determination that the minimum separation between the resource element of the one or more SL-PRS resource sets for the first transmitter UE and the resource element of the one or more SL-PRS resource sets for the second transmitter UE cannot be met, the UE may adjust a transmission power for the first transmitter UE. The transmission power for the first transmitter UE may be adjusted based on at least one of: reducing the transmission power for the first transmitter UE if a distance between the first transmitter UE and the second transmitter UE is equal to or smaller than a first threshold, or maintaining or increasing the transmission power for the first transmitter UE if the distance between the first transmitter UE and the second transmitter UE is greater than a second threshold. The first threshold and/or the second threshold may be configured or pre-configured.

In some embodiments, the UE may be a first transmitter UE, and may obtain, from a second transmitter UE, assistance information, such as information regarding one or more SL-PRS resource sets reserved by the second transmitter UE. Based on the information regarding the one or more SL-PRS resource sets reserved by the second transmitter UE, the UE (first transmitter UE) may further determine whether to select or re-select one or more SL-PRS resource sets. In some embodiments, the information regarding the one or more SL-PRS resource sets reserved by the second transmitter UE may be obtained based on at least one of: decoding sidelink control information (SCI) received from the second transmitter UE, or measuring one or more SL-PRS signals received from the second transmitter UE. Measuring the one or more SL-PRS signals received from the second transmitter UE may include measuring at least one of: reference signal received power (RSRP), received signal strength indicator (RSSI), reference signal received quality (RSRQ), or signal-to-noise and interference ratio (SINR) of the one or more SL-PRS signals. In some embodiments, the UE may exclude the one or more SL-PRS resource sets reserved by the second transmitter UE, in response to a determination of at least one of: (1) a separation between a resource element of the one or more SL-PRS resource sets for the first transmitter UE and a resource element of the one or more SL-PRS resource sets for the second transmitter UE is less than a first threshold, or (2) one or more signal metrics of the one or more SL-PRS resource sets reserved by the second transmitter UE exceeds a second threshold. The first threshold and the second threshold may be configured or pre-configured, defined, or pre-defined.

In some embodiments, the UE may be a transmitter UE that receives assistance information from a receiver UE. For example, the transmitter UE may receive at least one of: one or more signal metrics measured by the receiver UE on one or more SL-PRS signals received by the receiver UE, or one or more coordination indications. In some embodiments, the one or more signal metrics or one or more coordination indications may include at least one of: (1) reference signal received power RSRP of the one or more SL-PRS signals received by the receiver UE, (2) received signal strength indicator (RSSI) of the one or more SL-PRS signals received by the receiver UE, (3) reference signal received quality (RSRQ) of the one or more SL-PRS signals received by the receiver UE, (4) signal-to-noise and interference ratio (SINR) of the one or more SL-PRS signals received by the receiver UE, (5) one or more preferred SL-PRS resource sets for the transmitter UE, or (6) one or more non-preferred SL-PRS resource sets for the transmitter UE. In some embodiments, in selecting the at least one SL-PRS resource set, the UE may consider channel sensing information obtained by the transmitter UE and at least one of: the one or more signal metrics received from the receiver UE, or the one or more coordination indications received from the receiver UE. In some embodiments, the transmitter UE may receive, from the receiver UE, one or more conflict indications indicating existence of at least one SL-PRS transmission that affects reception of the one or more SL-PRS signals by the receiver UE.

In some embodiments, the selected at least one SL-PRS resource set may be dynamically activated or deactivated based on a determination of an accuracy in positioning. For example, in some embodiments, dynamic activation or deactivation of the selected at least one SL-PRS resource set may be performed by a network node (e.g., a base station, a location management function (LMF), or a server UE). In some embodiments, the UE may determine the accuracy in positioning by receiving the accuracy information from at least one of: the base station, the LMF, or the server UE.

The method 800 includes a step 806 of transmitting, based on the selected at least one SL-PRS resource set, at least one of: one or more SL-PRS signals or SL-PRS control information. In some embodiments, the UE may be a first transmitter UE that transmits, to one or more second transmitter UEs, via unicast, groupcast, or broadcast, the SL-PRS control information, via a direct communication or via a network node. In some embodiments, the UE may transmit, to one or more second transmitter UEs, via unicast, groupcast, or broadcast, the SL-PRS control information via SCI or medium access control protocol control element (MAC CE).

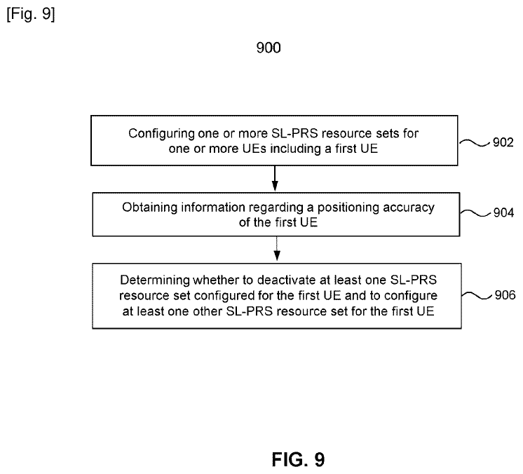

FIG. 9 is a schematic diagram illustrating a method involving a node for a sidelink positioning, consistent with some embodiments of the present disclosure. The node may be at least one of: a base station, an LMF, or a UE (e.g., a server UE). For example, in an embodiment, the node may be the anchor node 204 of FIG. 2.

Referring to FIG. 9, a method 900 includes a step 902 of configuring one or more SL-PRS resource sets for one or more UEs including a first UE. In some embodiments, the one or more SL-PRS resource sets may be a plurality of SL-PRS resource sets for a plurality of UEs including the first UE. The node may further configure the plurality of SL-PRS resource sets such that each of the plurality of SL-PRS resource sets is available for one or more slots. In some embodiments, the node may configure the one or more SL-PRS resource sets based on at least one of: one or more priorities of one or more SL-PRS signals for one or more UEs, or one or more congestion metrics associated with the one or more UEs. In some embodiments, the node may configure the one or more SL-PRS resource sets such that, in the one or more slots, the one or more SL-PRS resource sets are associated with one or more of an odd resource set index or an even resource set index. In some embodiments, the node may configure the one or more SL-PRS resource sets such that a separation between two resource elements for any two SL-PRS resource sets in the one or more SL-PRS resource sets is equal to or greater than an integer. In some embodiments, the two resource elements for any two SL-PRS resource sets in the one or more SL-PRS resource sets are two adjacent resource elements. The integer may be configured or pre-configured. In some embodiments, the separation between the two resource elements for any two SL-PRS resource sets in the one or more SL-PRS resource sets may be at least one of: a separation in frequency domain, or a separation in time domain.

In some embodiments, the node may configure the one or more SL-PRS resource sets such that a wider separation between two resource elements for any two SL-PRS resource sets in the one or more SL-PRS resource sets is used for one or more of a lower congestion level or a higher priority of a SL-PRS signal, and a narrower separation between two resource elements for any two SL-PRS resource sets in the one or more SL-PRS resource sets is used for one or more of a higher congestion level or a lower priority of a SL-PRS signal. The two resource elements for any two SL-PRS resource sets in the one or more SL-PRS resource sets may be two adjacent resource elements. The separation between the two resource elements for any two SL-PRS resource sets in the one or more SL-PRS resource sets may be at least one of: a separation in frequency domain, or a separation in time domain.

The method 900 includes a step 904 of obtaining information regarding a positioning accuracy of the first UE. For example, in some embodiments, the node may determine degradation of positioning accuracy of the first UE based on at least one of: the configuration of the one or more SL-PRS resource sets for the one or more UEs, one or more measurement reports on one or more SL-PRS signals transmitted from the one or more UEs, or one or more shared mobility patterns of one or more other UEs.

The method 900 includes a step 906 of determining whether to deactivate at least one SL-PRS resource set configured for the first UE and to configure at least one other SL-PRS resource set for the first UE. For example, in response to a determination that the positioning accuracy for the first UE is below a threshold, the node may dynamically deactivate the at least one SL-PRS resource set configured for the first UE. The node may further configure at least one other SL-PRS resource set for the first UE.

The methods described in this disclosure may be applied to any sidelink positioning. But the scope of the methods of the present disclosure is not so limited. In some embodiments, the methods may be applied to uplink/downlink (Uu) positioning, for example, using the DL-PRS resource mapping as shown in FIG. 3 or any variation thereof. The uplink/downlink positioning may use, for example, long term evolution (LTE) or new radio (NR) or a future generation (6G, 7G, or any future generation) radio access technology. The methods described in this disclosure may also be applied to other systems, for example, the systems that comply with other standards (e.g., the Institute of Electrical and Electronics Engineers (IEEE) standards including 802.11).

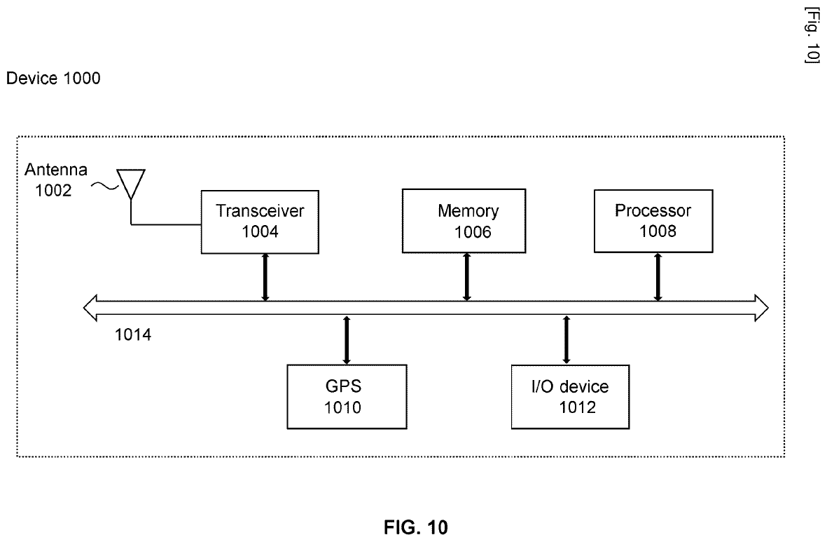

FIG. 10 is a block diagram of a device 1000, consistent with some embodiments of the present disclosure. For example, the device 1000 may be a node that obtains positioning information using sidelink positioning, such as the target node 202 of FIG. 2. For another example, the device 1000 may be a node, such as the anchor node 204 of FIG. 2 that is involved in sidelink positioning. For another example, the device 1000 may be a Tx UE, such as the Tx UE 502 or the Tx UE 504 of FIG. 5, that transmits data/signals to an Rx UE. For another example, the device 1000 may be a receiver UE, such as the Rx UE 506 of FIG. 5, that receives data/signals from one or more transmitter UEs. The device 1000 may take any form, including but not limited to, a vehicle, a component mounted in a vehicle, a road side unit, a laptop computer, a desktop computer, a server computer, a wireless terminal including a mobile phone, a wireless handheld device, or wireless personal device, or any other form.

Referring to FIG. 10, the device 1000 may include an antenna 1002 that may be used for transmission or reception of electromagnetic signals to/from network nodes or mobile nodes. The antenna 1002 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1002 may include multiple (e.g., tens or hundreds) antenna elements and may enable multi-antenna functions such as beamforming. In some embodiments, the antenna 1002 is a single antenna.

The device 1000 may include a transceiver 1004 that is coupled to the antenna 1002. The transceiver 1004 may be a wireless transceiver at the device 1000 and may communicate bi-directionally with a network node or a mobile node. For example, the transceiver 1004 may receive/transmit wireless signals (e.g., DL-PRS) from/to a base station via downlink/uplink communication. The transceiver 1004 may also receive/transmit wireless signals (e.g., SL-PRS) from/to a UE or a road side unit via sidelink communication. The transceiver 1004 may include a modem to modulate the packets and provide the modulated packets to the antenna 1002 for transmission, and to demodulate packets received from the antenna 1002.

The device 1000 may include a memory 1006. The memory 1006 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1006 may store information related to identities of the device 1000 and the signals and/or data received by the antenna 1002. The memory 1006 may also store post-processing signals and/or data. The memory 1006 may also store computer-readable program instructions, mathematical models, and algorithms that are used in signal processing in the transceiver 1004 and computations (e.g., computations for determining the coordinates of the device 1000) in a processor 1008 included as part of the device 1000. The memory 506 may further store computer-readable program instructions for execution by the processor 1008 to operate the device 1000 to perform various functions described in this disclosure. For example, the memory 1006 may store instructions for execution by the processor 1008 to operate the device 1000 to perform the method 800 of FIG. 8 and/or the method 900 of FIG. 9. In some examples, the memory 1006 may include a basic input/output system (BIOS) which may control basic hardware or software operation such as the interaction with peripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The processor 1008 that may include a hardware device with processing capabilities. The processor 1008 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1008 may be implemented using a combination of devices (e.g., a combination of a DSP and a microprocessor, multiple microprocessors, one or more microprocessors in conjunction with a DSP core, or any other such configuration). The processor 1008 may receive, from the transceiver 1004, downlink signals or sidelink signals and further process the signals. For example, the processor 1008 may further process the signals to determine the position of the device 1000. The processor 1008 may also receive, from the transceiver 1004, data packets and further process the packets. In some embodiments, the processor 1008 may be configured to operate a memory using a memory controller. In some embodiments, a memory controller may be integrated into the processor 1008. The processor 1008 may be configured to execute computer-readable instructions stored in a memory (e.g., the memory 1006) to cause the device 1000 to perform various functions.

The device 1000 may include a global positioning system (GPS) 1010. The GPS 1010 may be used for enabling location-based services or other services based on a geographical position of the device 1000 and/or synchronization among nodes. The GPS 1010 may receive GNSS signals from a single satellite or a plurality of satellite signals via the antenna 1002 and provide a geographical position of the device 1000 (e.g., coordinates of the device 1000). In some embodiments, the GPS 1010 is omitted. In some embodiments, a timer is included.

The device 1000 may include an input/output (I/O) device 1012 that may be used to communicate a result of signal processing and computation to a user or another device. The I/O device 1012 may include a user interface including a display and an input device to transmit a user command to the processor 1008. The display may be configured to display a status of signal reception at the device 1000, the data stored at the memory 1006, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The device 1000 may further include a machine interface 1014, such as an electrical bus that connects the transceiver 1004, the memory 1006, the processor 1008, the GPS 1010, and the I/O device 1012.

In some embodiments, the device 1000 may be a UE for a sidelink positioning (e.g., a UE that needs to obtain positioning information). The processor 1008 may be configured or programmed to execute the instructions stored in the memory 1006 to determine at least one of: one or more SL-PRS resource sets in a slot, or one or more SL-PRS resource set patterns for one or more slots, the one or more SL-PRS resource sets being configured or pre-configured for one or more SL-PRS transmissions for one or more UEs including the UE; select at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and transmit, based on the selected at least one SL-PRS resource set, at least one of: one or more SL-PRS signals or SL-PRS control information.

In some embodiments, the device 1000 may be a node for a sidelink positioning. The processor 1008 may be configured or programmed to execute the instructions stored in the memory 1006 to configure one or more SL-PRS resource sets for one or more UEs including a first UE; obtain information regarding a positioning accuracy of the first UE; and determine whether to deactivate at least one SL-PRS resource set configured for the first UE and to configure at least one other SL-PRS resource set for the first UE.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value or the value of range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A user equipment (UE) for a sidelink positioning, the UE comprising:
a memory storing an instruction; and
a processor configured to execute the instruction stored in the memory to:
   determine at least one of: one or more sidelink-positioning reference signal (SL-PRS) resource sets in a slot, or one or more SL-PRS resource set patterns for one or more slots, the one or more SL-PRS resource sets being configured or pre-configured for one or more SL-PRS transmissions for one or more UEs including the UE;
   select at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and
      transmit, based on the selected at least one SL-PRS resource set, at least one of: one or more SL-PRS signals or SL-PRS control information.

Clause 2: The UE of clause 1, wherein the one or more SL-PRS resource sets are one or more active SL-PRS resource sets that are configured or pre-configured to be available for at least one slot.

Clause 3: The UE of clause 1, wherein the one or more SL-PRS resource sets are configured or pre-configured such that each of the one or more SL-PRS resource sets has a corresponding SL-PRS resource identifier (ID).

Clause 4: The UE of clause 1, wherein the one or more SL-PRS resource sets are configured or pre-configured based on at least one of: one or more priorities of the one or more SL-PRS signals, or one or more congestion metrics associated with the one or more SL-PRS signals.

Clause 5: The UE of clause 4, wherein the one or more congestion metrics associated with the one or more SL-PRS signals comprise at least one of channel busy ratio (CBR) or channel occupancy ratio (CR).

Clause 6: The UE of clause 2, wherein the one or more SL-PRS resource sets are configured or pre-configured such that, in the at least one slot, the one or more SL-PRS resource sets are associated with an odd resource set index or an even resource set index.

Clause 7: The UE of clause 1, wherein the one or more SL-PRS resource sets are configured or pre-configured such that, in the at least one slot, a separation between two resource elements for any two SL-PRS resource sets in the one or more SL-PRS resource sets is equal to or greater than an integer.

Clause 8: The UE of clause 7, wherein the integer is configured or pre-configured.

Clause 9: The UE of clause 7, wherein the two resource elements for any two SL-PRS resource sets in the one or more SL-PRS resource sets are adjacent.

Clause 10: The UE of clause 7, wherein the separation between the two resource elements for any two SL-PRS resource sets in the one or more SL-PRS resource sets is at least one of: a separation in frequency domain, or a separation in time domain.

Clause 11: The UE of clause 1, wherein the one or more SL-PRS resource sets are configured or pre-configured such that a wider separation between two resource elements for any two SL-PRS resource sets in the one or more SL-PRS resource sets is used for a SL-PRS signal having at least one of: a lower congestion level or a higher priority, and a narrower separation between two resource elements for any two SL-PRS resource sets in the one or more SL-PRS resource sets is used for a SL-PRS signal having at least one of: a higher congestion level or a lower priority.

Clause 12: The UE of clause 11, wherein the two resource elements for any two SL-PRS resource sets in the one or more SL-PRS resource sets are adjacent.

Clause 13: The UE of clause 11, wherein the separation between the two resource elements for any two SL-PRS resource sets in the one or more SL-PRS resource sets is at least one of: a separation in frequency domain, or a separation in time domain.

Clause 14: The UE of clause 1, wherein the one or more SL-PRS resource set patterns comprise a plurality of SL-PRS resource set patterns and the one or more slots are associated with at least one SL-PRS resource set pattern from among the one or more SL-PRS resource set patterns.

Clause 15: The UE of clause 14, wherein the one or more SL-PRS resource set patterns are configured or pre-configured, and each of the one or more SL-PRS resource set patterns is associated with the one or more slots.

Clause 16: The UE of clause 14, wherein the at least one SL-PRS resource set pattern associated with the one or more slots is different from one or more SL-PRS resource set patterns of an integer number of adjacent slots, the integer being configured or pre-configured.

Clause 17: The UE of clause 14, wherein the at least one SL-PRS resource set pattern is associated with an integer number of consecutive slots, the integer being configured or pre-configured.

Clause 18: The UE of clause 14, wherein the at least one SL-PRS resource set pattern is associated with one or more slots identified by one or more mapping tables, the one or more mapping tables including a mapping between the at least one SL-PRS resource set pattern and the identified one or more slots, the one or more mapping tables being configured or pre-configured.

Clause 19: The UE of clause 2, wherein the processor is configured to execute the instruction stored in the memory to:
select, from the one or more SL-PRS resource sets, at least one specific SL-PRS resource set corresponding to the UE, for the at least one slot.

Clause 20: The UE of clause 1, wherein the one or more SL-PRS resource sets are a plurality of SL-PRS resource sets configured or pre-configured for a plurality of UEs including the UE, each of the plurality of UEs being associated with a corresponding SL-PRS resource set of the plurality of SL-PRS resource sets.

Clause 21: The UE of clause 1, wherein the processor is configured to execute the instruction stored in the memory to: use, for each SL-PRS transmission, a different SL-PRS resource set from among the one or more SL-PRS resource sets, based on one or more rotation patterns of selection, the one or more rotation patterns being configured by a network node or pre-configured at the UE.

Clause 22: The UE of clause 21, wherein the one or more rotation patterns are derived based on at least one of: a zone at which the UE is located, an anchor group associated with the UE, or a positioning session associated with the UE.

Clause 23: The UE of clause 1, wherein the processor is configured to execute the instruction stored in the memory to:
select, from the one or more SL-PRS resource sets, randomly or based on obtained channel sensing information, at least one specific SL-PRS resource set corresponding to the UE, for one or more SL-PRS signal transmissions.

Clause 24: The UE of clause 23, wherein the at least one SL-PRS resource set is selected for at least one of: one or more initial transmissions in a semi-persistent scheduling (SPS), one or more retransmissions in a SPS, or one or more transmissions in one-shot transmission.

Clause 25: The UE of clause 1, wherein the processor is configured to execute the instruction stored in the memory to:
select, from among one or more available radio resources with granularity of at least one of: one or more time resources or one or more frequency resources, randomly or based on obtained channel sensing information, one or more radio resources with granularity of at least one of: one or more slots or one or more sub-channels; and
select, from among the selected one or more radio resources, randomly or based on the obtained channel sensing information, the one or more SL-PRS resource sets, with a granularity of a SL-PRS resource set.

Clause 26: The UE of clause 25, wherein the granularity of at least one of: one or more time resources or one or more frequency resources is the granularity of at least one of: one or more slots or one or more sub-channels.

Clause 27: The UE of clause 1, wherein the UE is a first transmitter UE, and the processor is configured to execute the instruction stored in the memory to:
transmit, to one or more second transmitter UEs via unicast, groupcast, or broadcast, the SL-PRS control information, via a direct communication or via a network node.

Clause 28: The UE of clause 1, wherein the UE is a first transmitter UE, and the processor is configured to execute the instruction stored in the memory to:
receive, from a second transmitter UE, SL-PRS control information generated by the second transmitter UE, the received SL-PRS control information including SL-PRS resource set information for the second transmitter UE for at least one of: one or more current SL-PRS transmissions, or one or more subsequent transmissions.

Clause 29: The UE of clause 28, wherein the SL-PRS control information is received via a direct communication or via a network node.

Clause 30: The UE of clause 28, wherein the processor is configured to execute the instruction stored in the memory to:
determine, based on the received SL-PRS control information, whether to select or re-select one or more SL-PRS resource sets, while ensuring a minimum separation between a resource element of the one or more SL-PRS resource sets for the first transmitter UE and a resource element of the one or more SL-PRS resource sets for the second transmitter UE.

Clause 31: The UE of clause 30, wherein the minimum separation is configured or pre-configured.

Clause 32: The UE of clause 28, wherein the processor is configured to execute the instruction stored in the memory to:
determine whether to adjust a transmitter power for the first transmitter UE, based on at least one of: a position of the first transmitter UE, a position of the second transmitter UE, a mobility of the first transmitter UE, or a mobility of the second transmitter UE.

Clause 33: The UE of clause 30, wherein the processor is configured to execute the instruction stored in the memory to:
in response to a determination that the minimum separation between the resource element of the one or more SL-PRS resource sets for the first transmitter UE and the resource element of the one or more SL-PRS resource sets for the second transmitter UE cannot be met, adjust a transmission power for the first transmitter UE.

Clause 34: The UE of clause 33, wherein the transmission power for the first transmitter UE is adjusted based on at least one of: reducing the transmission power for the first transmitter UE if a distance between the first transmitter UE and the second transmitter UE is equal to or smaller than a first threshold, or maintaining or increasing the transmission power for the first transmitter UE if the distance between the first transmitter UE and the second transmitter UE is greater than a second threshold.

Clause 35: The UE of clause 1, wherein the selected at least one SL-PRS resource set is dynamically activated or deactivated based on a determination of an accuracy in positioning.

Clause 36: The UE of clause 35, wherein the determination is performed by receiving the accuracy information from at least one of: a base station, a location management function (LMF), or a server UE.

Clause 37: The UE of clause 1, wherein the UE is a first transmitter UE, and the processor is configured to execute the instruction stored in the memory to:
obtain, from a second transmitter UE, information regarding one or more SL-PRS resource sets reserved by the second transmitter UE; and
determine, based on the information regarding the one or more SL-PRS resource sets reserved by the second transmitter UE, whether to select or re-select one or more SL-PRS resource sets.

Clause 38: The UE of clause 37, wherein the information regarding the one or more SL-PRS resource sets reserved by the second transmitter UE is obtained based on at least one of: decoding sidelink control information (SCI) received from the second transmitter UE, or measuring one or more SL-PRS signals received from the second transmitter UE.

Clause 39: The UE of clause 38, wherein measuring the one or more SL-PRS signals received from the second transmitter UE comprises measuring at least one of: reference signal received power (RSRP), received signal strength indicator (RSSI), reference signal received quality (RSRQ), or signal-to-noise and interference ratio (SINR) of the one or more SL-PRS signals.

Clause 40: The UE of clause 37, wherein the processor is configured to execute the instruction stored in the memory to:
exclude the one or more SL-PRS resource sets reserved by the second transmitter UE, in response to a determination of at least one of: (1) a separation between a resource element of the one or more SL-PRS resource sets for the first transmitter UE and a resource element of the one or more SL-PRS resource sets for the second transmitter UE is less than a first threshold, or (2) one or more signal metrics of the one or more SL-PRS resource sets reserved by the second transmitter UE exceeds a second threshold.

Clause 41: The UE of clause 1, wherein the UE is a transmitter UE, and the processor is configured to execute the instruction stored in the memory to:
receive, from a receiver UE, at least one of: one or more signal metrics measured by the receiver UE on one or more SL-PRS signals received by the receiver UE, or one or more coordination indications.

Clause 42: The UE of clause 41, wherein the one or more signal metrics or the one or more coordination indications comprise at least one of: (1) RSRP of the one or more SL-PRS signals received by the receiver UE, (2) RSSI of the one or more SL-PRS signals received by the receiver UE, (3) RSRQ of the one or more SL-PRS signals received by the receiver UE, (4) SINR of the one or more SL-PRS signals received by the receiver UE, (5) one or more preferred SL-PRS resource sets for the transmitter UE, or (6) one or more non-preferred SL-PRS resource sets for the transmitter UE.

Clause 43: The UE of clause 42, wherein the processor is configured to execute the instruction stored in the memory to: consider channel sensing information obtained by the transmitter UE and at least one of: the one or more signal metrics received from the receiver UE or the one or more coordination indications received from the receiver UE, in selecting the at least one SL-PRS resource set.

Clause 44: The UE of clause 1, wherein the UE is a transmitter UE, and the processor is configured to execute the instruction stored in the memory to:
receive, from a receiver UE, one or more conflict indications, the one or more conflict indications indicating existence of at least one SL-PRS transmission that affects reception of the one or more SL-PRS signals by the receiver UE.

Clause 45: The UE of clause 1, wherein the one or more received control signals comprise at least one of: (1) SL-PRS resource set information for one or more initial transmissions in a current SPS period, (2) SL-PRS resource set information for one or more retransmissions in the current SPS period, (3) SL-PRS resource set information for one or more initial transmissions in at least one subsequent SPS period, or (4) SL-PRS resource set information for one or more retransmissions in at least one subsequent SPS period.

Clause 46: The UE of clause 1, wherein the UE is a first transmitter UE, and the processor is configured to execute the instruction stored in the memory to: transmit, to one or more second transmitter UEs via unicast, groupcast, or broadcast, the SL-PRS control information via SCI or medium access control protocol control element (MAC CE).

Clause 47: The UE of clause 1, wherein the slot is a slot of a dedicated SL-PRS resource pool or a slot of a shared SL-PRS resource pool.

Clause 48: The UE of clause 1, wherein one or more of the one or more SL-PRS resource sets is at least one of: one or more time resources, or one or more frequency resources.

Clause 49: The UE of clause 1, wherein each of the one or more SL-PRS resource sets is associated with at least one of: a SL-PRS resource ID, a SL-PRS comb size, a SL-PRS comb offset, a starting symbol of the slot, or a number of SL-PRL symbols within the slot.

Clause 50: A node for a sidelink positioning, the node comprising:
a memory storing an instruction; and
a processor configured to execute the instruction stored in the memory to:
   configure one or more sidelink-positioning reference signal (SL-PRS) resource sets for one or more user equipment (UEs) including a first UE;
   obtain information regarding a positioning accuracy of the first UE; and
   determine whether to deactivate at least one SL-PRS resource set configured for the first UE and to configure at least one other SL-PRS resource set for the first UE.

Clause 51: The node of clause 50, wherein the node comprises at least one of: a base station, a location management function (LMF), or a UE other than the one or more UEs.

Clause 52: The node of clause 51, wherein the UE other than the one or more UEs is a server UE.

Clause 53: The node of clause 50, wherein the processor is configured to execute the instruction stored in the memory to:
determine degradation of positioning accuracy of the first UE based on at least one of: the configuration of the one or more SL-PRS resource sets for the one or more UEs, one or more measurement reports on one or more SL-PRS signals transmitted from the one or more UEs, or one or more shared mobility patterns of one or more other UEs.

Clause 54: The node of clause 50, wherein the one or more SL-PRS resource sets are a plurality of SL-PRS resource sets for a plurality of UEs including the first UE, and processor is configured to execute the instruction stored in the memory to: configure the plurality of SL-PRS resource sets such that each of the plurality of SL-PRS resource sets is available for one or more slots.

Clause 55: The node of clause 50, wherein the processor is configured to execute the instruction stored in the memory to: configure the one or more SL-PRS resource sets based on at least one of: one or more priorities of one or more SL-PRS signals for one or more UEs, or one or more congestion metrics associated with the one or more UEs.

Clause 56: The node of clause 50, wherein the processor is configured to execute the instruction stored in the memory to: configure the one or more SL-PRS resource sets such that, in the one or more slots, the one or more SL-PRS resource sets are associated with one or more of an odd resource set index or an even resource set index.

Clause 57: The node of clause 50, wherein the processor is configured to execute the instruction stored in the memory to: configure the one or more SL-PRS resource sets such that a separation between two resource elements for any two SL-PRS resource sets in the one or more SL-PRS resource sets is equal to or greater than an integer.

Clause 58: The node of clause 57, wherein the two resource elements are adjacent.

Clause 59: The node of clause 57, wherein the integer is configured or pre-configured.

Clause 60: The node of clause 57, wherein the separation between the two resource elements for any two SL-PRS resource sets in the one or more SL-PRS resource sets is at least one of: a separation in frequency domain, or a separation in time domain.

Clause 61: The node of clause 50, wherein the processor is configured to execute the instruction stored in the memory to: configure the one or more SL-PRS resource sets such that a wider separation between two resource elements for any two SL-PRS resource sets in the one or more SL-PRS resource sets is used for one or more of a lower congestion level or a higher priority of a SL-PRS signal, and a narrower separation between two resource elements for any two SL-PRS resource sets in the one or more SL-PRS resource sets is used for one or more of a higher congestion level or a lower priority of a SL-PRS signal.

Clause 62: The node of clause 61, wherein the two resource elements for any two SL-PRS resource sets in the one or more SL-PRS resource sets are adjacent.

Clause 63: The node of clause 61, wherein the separation between the two resource elements for any two SL-PRS resource sets in the one or more SL-PRS resource sets is at least one of: a separation in frequency domain, or a separation in time domain.

Clause 64: A method for a user equipment (UE) in a sidelink positioning, the method comprising:
determining at least one of: one or more sidelink-positioning reference signal (SL-PRS) resource sets in a slot, or one or more SL-PRS resource set patterns for one or more slots, the one or more SL-PRS resource sets being configured or pre-configured for one or more SL-PRS transmissions for one or more UEs including the UE;
selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and
transmitting, based on the selected at least one SL-PRS resource set, at least one of: one or more SL-PRS signals or SL-PRS control information.

Clause 65: A method for a node for a sidelink positioning, the method comprising:
configuring one or more sidelink-positioning reference signal (SL-PRS) resource sets for one or more user equipment (UEs) including a first UE;
obtaining information regarding a positioning accuracy of the first UE; and
determining whether to deactivate at least one SL-PRS resource set configured for the first UE and to configure at least one other SL-PRS resource set for the first UE.

Clause 66: A non-transitory computer-readable medium storing instructions that are executable by one or more processors of a user equipment (UE) in a sidelink positioning, to perform a method, the method comprising:
determining at least one of: one or more sidelink-positioning reference signal (SL-PRS) resource sets in a slot, or one or more SL-PRS resource set patterns for one or more slots, the one or more SL-PRS resource sets being configured or pre-configured for one or more SL-PRS transmissions for one or more UEs including the UE;
selecting at least one SL-PRS resource set from the one or more SL-PRS resource sets based on at least one of: a random selection, the one or more SL-PRS resource set patterns, one or more received control signals, assistance information received from at least one other UE that differs from the UE, or assistance information received from a network node; and
transmitting, based on the selected at least one SL-PRS resource set, at least one of: one or more SL-PRS signals or SL-PRS control information.

Clause 67: A non-transitory computer-readable medium storing instructions that are executable by one or more processors of a node for a sidelink positioning, to perform a method, the method comprising:
configuring one or more sidelink-positioning reference signal (SL-PRS) resource sets for one or more user equipment (UEs) including a first UE;
obtaining information regarding a positioning accuracy of the first UE; and
determining whether to deactivate at least one SL-PRS resource set configured for the first UE and to configure at least one other SL-PRS resource set for the first UE.

1. A user equipment (UE) for a sidelink positioning, the UE comprising:
a memory storing an instruction; and
a processor configured to execute the instruction stored in the memory to:
determine one or more sidelink-positioning reference signal (SL-PRS) resource sets in a slot, the one or more SL-PRS resource sets being configured or pre-configured for one or more SL-PRS transmissions for one or more UEs including the UE;
select at least one SL-PRS resource set from the one or more SL-PRS resource sets based on at least a random selection and one or more SL-PRS control information received from at least one other UE that differs from the UE; and
transmit, based on the selected at least one SL-PRS resource set, at least one of: one or more SL-PRS signals or SL-PRS control information.

2. The UE of claim 1, wherein the one or more SL-PRS resource sets are one or more active SL-PRS resource sets that are configured or pre-configured to be available for at least one slot.

3. The UE of claim 1, wherein the one or more SL-PRS resource sets are configured or pre-configured such that each of the one or more SL-PRS resource sets has a corresponding SL-PRS resource identifier (ID).

4. The UE of claim 1, wherein the one or more SL-PRS resource sets are configured or pre-configured based on at least one of: one or more priorities of the one or more SL-PRS signals, or one or more congestion metrics associated with the one or more SL-PRS signals.

5. The UE of claim 1, wherein the one or more SL-PRS resource sets are configured or pre-configured such that, in the at least one slot, a separation between two resource elements for any two SL-PRS resource sets in the one or more SL-PRS resource sets is equal to or greater than an integer.

6. The UE of claim 1, wherein the one or more SL-PRS resource sets are configured or pre-configured such that a wider separation between two resource elements for any two SL-PRS resource sets in the one or more SL-PRS resource sets is used for a SL-PRS signal having at least one of: a lower congestion level or a higher priority, and a narrower separation between two resource elements for any two SL-PRS resource sets in the one or more SL-PRS resource sets is used for a SL-PRS signal having at least one of: a higher congestion level or a lower priority.

7. The UE of claim 1, wherein the one or more UEs including the UE are a plurality of UEs including the UE and the one or more SL-PRS resource sets are a plurality of SL-PRS resource sets configured or pre-configured for the plurality of UEs including the UE, each of the plurality of UEs being associated with a corresponding SL-PRS resource set of the plurality of SL-PRS resource sets.

8. The UE of claim 1, wherein the processor is configured to execute the instruction stored in the memory to: use, for each SL-PRS transmission, a different SL-PRS resource set from among the one or more SL-PRS resource sets, based on one or more rotation patterns of selection, the one or more rotation patterns being configured by a network node or pre-configured at the UE.

9. The UE of claim 1, wherein the processor is configured to execute the instruction stored in the memory to:
select, from the one or more SL-PRS resource sets, based on obtained channel sensing information, at least one specific SL-PRS resource set corresponding to the UE, for one or more SL-PRS signal transmissions.

10. The UE of claim 1, wherein the processor is configured to execute the instruction stored in the memory to:
select, from among one or more available radio resources with granularity of at least one of: one or more time resources or one or more frequency resources, based on obtained channel sensing information, one or more radio resources with granularity of at least one of: one or more slots or one or more sub-channels; and
select, from among the selected one or more radio resources, based on the obtained channel sensing information, the one or more SL-PRS resource sets, with a granularity of a SL-PRS resource set.

11. The UE of claim 1, wherein the UE is a first transmitter UE, and the processor is configured to execute the instruction stored in the memory to:
transmit, to one or more second transmitter UEs via unicast, groupcast, or broadcast, at least one of: the one or more SL-PRS signals or the SL-PRS control information, via a direct communication or via a network node.

12. The UE of claim 1, wherein the UE is a first transmitter UE, and the processor is configured to execute the instruction stored in the memory to:
receive, from a second transmitter UE, SL-PRS control information generated by the second transmitter UE, the received SL-PRS control information including SL-PRS resource set information for the second transmitter UE for at least one of: one or more current SL-PRS transmissions, or one or more subsequent transmissions.

13. The UE of claim 1, wherein the selected at least one SL-PRS resource set is dynamically activated or deactivated based on a determination of an accuracy in positioning.

14. The UE of claim 1, wherein the UE is a first transmitter UE, and the processor is configured to execute the instruction stored in the memory to:
obtain, from a second transmitter UE, information regarding one or more SL-PRS resource sets reserved by the second transmitter UE; and
determine, based on the information regarding the one or more SL-PRS resource sets reserved by the second transmitter UE, whether to select or re-select one or more SL-PRS resource sets.

15. The UE of claim 1, wherein the UE is a transmitter UE, and the processor is configured to execute the instruction stored in the memory to:
receive, from a receiver UE, at least one of: one or more signal metrics measured by the receiver UE on one or more SL-PRS signals received by the receiver UE, or one or more coordination indications.

16. The UE of claim 1, wherein the UE is a transmitter UE, and the processor is configured to execute the instruction stored in the memory to:
receive, from a receiver UE, one or more conflict indications, the one or more conflict indications indicating existence of at least one SL-PRS transmission that affects reception of the one or more SL-PRS signals by the receiver UE.

17. The UE of claim 1, wherein the one or more SL-PRS control information comprise at least one of: (1) SL-PRS resource set information for one or more initial transmissions in a current SPS period, (2) SL-PRS resource set information for one or more retransmissions in the current SPS period, (3) SL-PRS resource set information for one or more initial transmissions in at least one subsequent SPS period, or (4) SL-PRS resource set information for one or more retransmissions in at least one subsequent SPS period.

18. The UE of claim 1, wherein the slot is a slot of a dedicated SL-PRS resource pool or a slot of a shared SL-PRS resource pool.

19. The UE of claim 1, wherein one or more of the one or more SL-PRS resource sets is at least one of: one or more time resources, or one or more frequency resources.

20. The UE of claim 1, wherein each of the one or more SL-PRS resource sets is associated with at least one of: a SL-PRS resource ID, a SL-PRS comb size, a SL-PRS comb offset, a starting symbol of the slot, or a number of SL-PRL symbols within the slot.

21. A method for a user equipment (UE) in a sidelink positioning, the method comprising:
determining one or more sidelink-positioning reference signal (SL-PRS) resource sets in a slot, the one or more SL-PRS resource sets being configured or pre-configured for one or more SL-PRS transmissions for one or more UEs including the UE;
selecting at least one SL-PRS resource set from the one or more SL-PRS resource sets based on at least a random selection and one or more SL-PRS control information received from at least one other UE that differs from the UE; and
transmitting, based on the selected at least one SL-PRS resource set, at least one of: one or more SL-PRS signals or SL-PRS control information.

22. A non-transitory computer-readable medium storing instructions that are executable by one or more processors of a user equipment (UE) in a sidelink positioning, to perform a method, the method comprising:
determining one or more sidelink-positioning reference signal (SL-PRS) resource sets in a slot, the one or more SL-PRS resource sets being configured or pre-configured for one or more SL-PRS transmissions for one or more UEs including the UE;
selecting at least one SL-PRS resource set from the one or more SL-PRS resource sets based on at least a random selection and one or more SL-PRS control information received from at least one other UE that differs from the UE; and
transmitting, based on the selected at least one SL-PRS resource set, at least one of: one or more SL-PRS signals or SL-PRS control information.
